(19) United States
(12) Patent Application Publication
(10) Pub. No.: US 2011/0232765 A1
(43) Pub. Date: Sep. 29, 2011

(54) VALVING DEVICE AND METHOD

(75) Inventors: Paul Joseph, Missouri City, TX (US); Luis Mendez, Houston, TX (US)

(73) Assignee: BAKER HUGHES INCORPORATED, Houston, TX (US)

(21) Appl. No.: 12/731,570

(22) Filed: Mar. 25, 2010

(51) Int. Cl. F15D 1/00; F16K 5/00

(52) U.S. Cl. 137/1; 251/304

(57) ABSTRACT

A valving device includes a body having a bore hole and a slot, the slot providing fluidic communication between the bore hole and an outside of the body. A cylinder is rotationally movably engaged within the bore hole and has an opening providing fluidic communication between an outer radial surface of the cylinder and a cavity therewithin. The valving device is configured to alter a portion of the slot in fluidic communication with the opening.

### BACKGROUND

Valves that open and close flow channels are commonly used in a wide variety of industries including downhole drilling and completion industries. Many such valves are limited to being either fully open or fully closed. New valves that can open to flow areas between fully open and fully closed are desirable in the art.

### BRIEF DESCRIPTION

Disclosed herein is a valving device that includes a body having a bore hole and a slot, the slot providing fluidic communication between the bore hole and an outside of the body. A cylinder is rotationally movably engaged within the bore hole and has an opening providing fluidic communication between an outer radial surface of the cylinder and a cavity therewithin. The valving device is configured to alter a portion of the slot in fluidic communication with the opening.

Further disclosed herein is a method of operating a valve. The method includes, rotating a cylinder engaged within a bore hole in a body, and continuously varying an area of fluid communication between an outside of the body and a cavity within the cylinder.

### BRIEF DESCRIPTION OF THE DRAWINGS

The following descriptions should not be considered limiting in any way. With reference to the accompanying drawings, like elements are numbered alike:

FIG. 1 depicts a partially cross-sectioned perspective view of a valving device disclosed herein shown partially open;

FIG. 2 depicts a partially cross-sectioned top view of the valving device of FIG. 1, shown at the same level of opening as in FIG. 1;

FIG. 3 depicts a partially cross-sectioned top view of the valving device of FIG. 1, shown with the valving device fully closed;

FIG. 4 depicts a partially cross-sectioned top view of the valving device of FIG. 1, shown with the valving device fully open; and

FIG. 5 depicts a cross-sectioned end view of the valving device of FIG. 2 taken along arrows 5-5.

### DETAILED DESCRIPTION

A detailed description of one or more embodiments of the disclosed apparatus and method are presented herein by way of exemplification and not limitation with reference to the Figures.

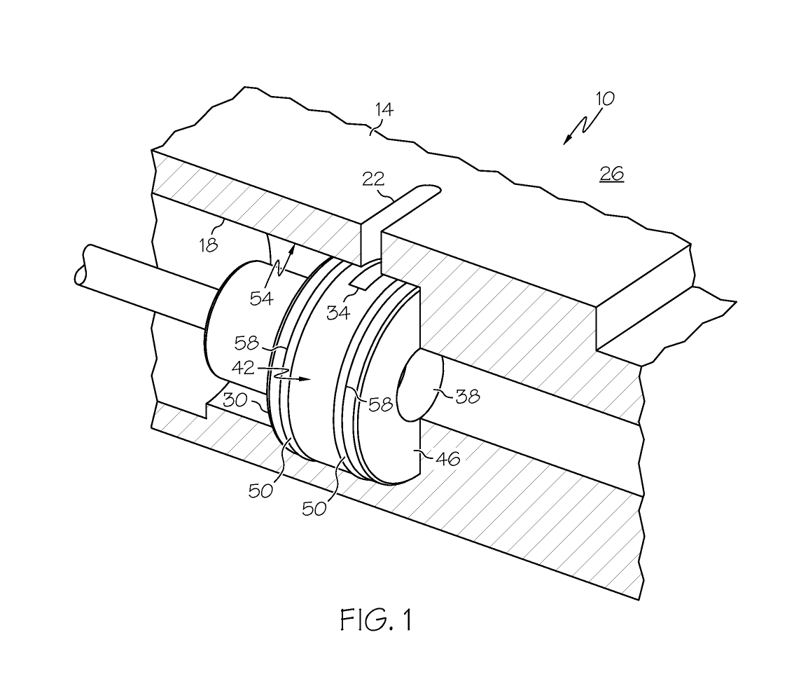

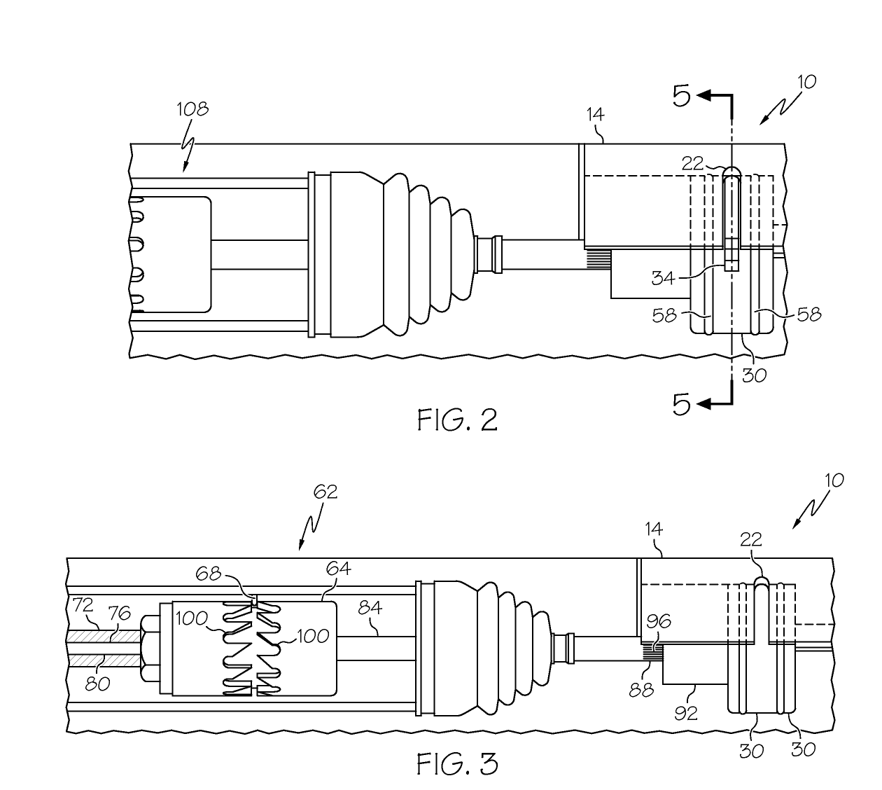

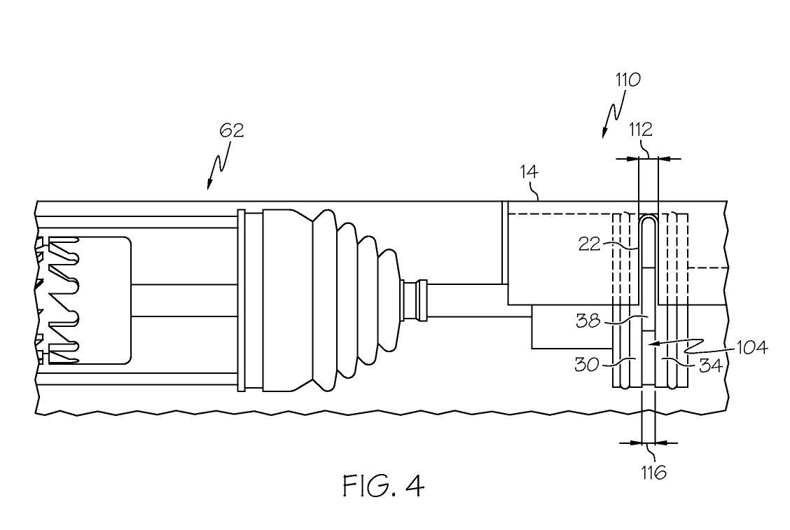

Referring to FIGS. 1-4, an embodiment of the valving device disclosed herein is illustrated at 10. The valving device 10 includes, a body 14 having a bore hole 18 and a slot 22 fluidically connecting the bore hole 18 to an outside 26 of the body 14, and a cylinder 30 rotationally slidably engaged within the bore hole 18 having an opening 34 fluidically connecting a cavity 38 therein to a radially outer surface 42 of the cylinder 30. The cavity 38 in this embodiment is fluidically connected to a longitudinal end 46 of the cylinder 30. The valving device 10 is configured to vary a portion of the opening 34 that is in fluidic communication with the slot 22 in response to rotation of the cylinder 30 relative to the body 14. As such, the valving device 10 allows the portion of the opening 34 that is in fluidic communication with the slot 22 to be continuously variable between a fully closed position, as illustrated in FIG. 3, a fully open position, as illustrated in FIG. 4, and anywhere in between, such as the partially open position as illustrated in FIGS. 1 and 2. The portion of the slot 22 being in fluidic communication with the opening 34 defines a flow passageway through the valving device 10 between the outside 26 and the cavity 38.

Optionally, seals 50 can be used to seal the radially outer surface 42 of the cylinder 30 to an inner radial wall 54 of the bore hole 18 to minimize leakage between the cylinder 30 and the body 14. The seals 50 can be elastomeric o-rings, as illustrated in this embodiment, that are retained within perimetrical grooves 58 formed in the radially outer surface 42, for example. Alternately, the seals 50 could be metallic rings that are spring loaded radially outwardly, for example, or could be formed by the closeness of the fit between the radially outer surface 42 and the inner radial wall 54.

Referring specifically to FIG. 3, the cylinder 30 can be rotated relative to the body 14 by a rotational actuator 62. The rotational actuator 62 shown in this embodiment includes a J-slot 64 that moves in relation to a pin 68 fixedly attached to the body 14. Relative longitudinal motion of the J-slot 64 and the pin 68 is accomplished via heating and cooling of a shape memory alloy 72 that longitudinally expands and contracts with changes in temperature. A heater 76, such as an electrical heater, positioned within a bore 80 of the shape memory alloy 72 can be energized, and denergized, remotely to effectively change the temperature, and consequently the length of the shape memory alloy 72. A shaft 84 attached to the shape memory alloy 72 has an end 88 engaged with a collar 92 of the cylinder 30 to cause the cylinder 30 to rotate when the J-slot 64 rotates. A spline 96 on the shaft 84 rotationally locks the collar 92 and the cylinder 30 to the shaft 84 while allowing the shaft 96 to move longitudinally relative thereto. This construction allows the slot 22 to remain in longitudinal alignment with the opening 34 while the cylinder 30 rotates relative to the body 14. A plurality of positions 100 along the J-slot 64 define a plurality of differing amounts of overlap between the slot 22 and the opening 34 thereby defining a plurality of differing areas of flow passageways through the valving device 10. With the J-slot 64, of this embodiment, configured to rotate the cylinder 30 in a single direction, the plurality of positions 100 occurs sequentially.

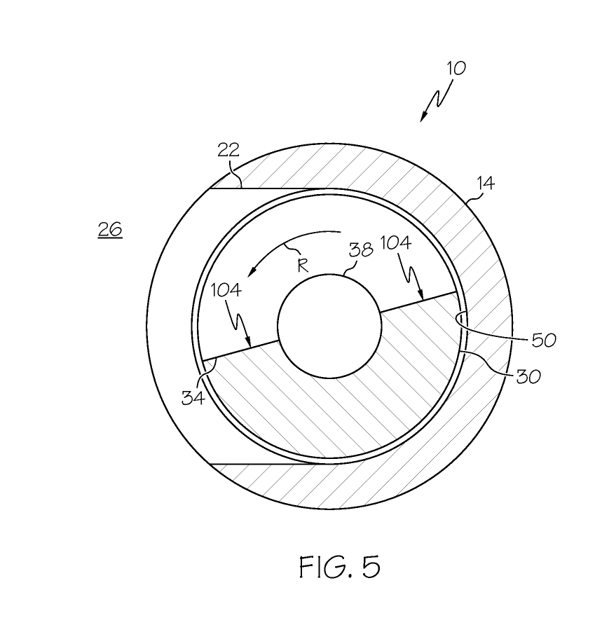

Referring to FIG. 5, the foregoing rotational actuator 62, by rotationally indexing the cylinder 30 in a single rotational direction relative to the body 14, can cause the valving device 10 to repeatedly increasingly open and increasingly close. The valving device 10 in the position, as illustrated in FIG. 5, is a little more than half open. This is due to the surface 104 that defines the opening 34 being positioned past the horizontal position as viewed in response to rotating the cylinder 30 in the direction of arrow R. Once the surface 104 is oriented vertically facing leftward in the view the valving device 10 will be fully open. Continued rotation of the cylinder 30 therepast, in the direction of arrow R, will increasingly close the valving device 10 until it is fully closed as defined by the surface 104 being vertical again but facing rightward in the view of FIG. 5. As such, the open area defined by the overlap of the slot 22 with the opening 34 will vary linearly with relative rotation of the cylinder 30 with respect to the body 14.

An alternate embodiment can use an alternate rotational actuator 108 (FIG. 2) that is not limited specifically to the plurality of positions 100, for example, but instead is rotationally stoppable at any rotational position. The rotational actuator 108 can permit the valving device to be open to an infinite number of possible flow areas.

An embodiment of the valving device 10 having the body 14 made into a tubular shape, as it does in FIG. 5, would be well suited for usage along a completion string, for example, in a downhole application. Such an application would allow an operator to control the valving device to a plurality of variably opened positions between the outside 26 of the completion string and the cavity 38 located therewithin.

Referring again to FIG. 4, in an alternate embodiment of the valving device 10 a longitudinal dimension 112 of the slot 22 can vary over the perimetrical extent of the slot 22. Similarly, a longitudinal dimension 116 of the opening 34 can vary over the perimetrical extent of the opening 34. These varying longitudinal dimensions 112, 116 can be used singly or in combination to create a nonlinear relationship between rotational movements of the cylinder 30 with respect to the body 14. Such a nonlinear relationship can allow for more precise control over changing a size of flow passageways through the valving device 10 for some rotational movements of the cylinder 30 than others.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A valving device comprising:
a body having a bore hole and a slot, the slot providing fluidic communication between the bore hole and an outside of the body; and
a cylinder rotationally movably engaged within the bore hole, having an opening providing fluidic communication between an outer radial surface of the cylinder and a cavity therewithin, the valving device being configured to alter a portion of the slot in fluidic communication with the opening.

2. The valving device of claim 1, wherein the portion of the slot that can be in fluidic communication with the opening varies between zero and one hundred percent.

3. The valving device of claim 1, wherein the portion of the slot that is in fluidic communication with the opening defines a size of a flow passageway through the valving device.

4. The valving device of claim 1, wherein the portion of the slot that is in fluidic communication with the opening is continuously variable.

5. The valving device of claim 1, wherein the opening is configured to extend through substantially half of a circumference of the cylinder.

6. The valving device of claim 1, wherein the slot engages with substantially half of an inner circumferential surface defined by the bore hole.

7. The valving device of claim 1, wherein an area of overlap between the slot and the opening varies linearly with rotation of the cylinder.

8. The valving device of claim 1, wherein the body is a tubular

9. The valving device of claim 1, further comprising a rotational actuator in operable communication with at least one of the body and the cylinder.

10. The valving device of claim 9, wherein the rotational actuator includes a shape memory alloy.

11. The valving device of claim 10, wherein the shape memory alloy is in operable communication with a J-slot.

12. The valving device of claim 11, wherein the J-slot is configured to rotationally index the cylinder relative to the body.

13. The valving device of claim 12, wherein a plurality of indexed positions defines increasing areas of overlap between the slot and the opening.

14. The valving device of claim 13, wherein the plurality of indexed positions is sequential.

15. The valving device of claim 1, wherein a longitudinal dimension of at least one of the slot and the opening varies over a perimetrical extent thereof.

16. The valving device of claim 1, further comprising at least two seals sealingly engaged with both the cylinder and the body, and at least two of the at least two seals are disposed at opposing longitudinal sides of the opening.

17. The valving device of claim 16, wherein the at least two seals are elastomeric.

18. The valving device of claim 16, wherein one of the body and the cylinder have perimetrical grooves that retain the at least two seals.

19. The valving device of claim 1, wherein the body is disposed at a completion string.

20. The valving device of claim 1, wherein the cavity extends longitudinally to at least one end of the cylinder.

21. A method of operating a valve, comprising:
rotating a cylinder engaged within a bore hole in a body; and
continuously varying an area of fluid communication between an outside of the body and a cavity within the cylinder.
